(19) United States
(12) Patent Application Publication
(10) Pub. No.: US 2003/0196854 A1
(43) Pub. Date: Oct. 23, 2003

(54) Ladder support rod system

(76) Inventor: Terry A. Beczak SR., Henderson, NV (US)

Correspondence Address: Michael S. Neustel, Suite No. 4, 2534 South University Drive, Fargo, ND, 58103, US

(21) Appl. No.: 10/124,387

(22) Filed: Apr. 18, 2002

(51) Int. Cl. E06C 7/00

(52) U.S. Cl. 182/129

(57) ABSTRACT

A ladder support rod system for supporting various types of objects in an elevated manner adjacent a ladder. The ladder support rod system includes an elongate member capable of slidably fitting within a lumen of a rung, a first end member adjustably attached to an end of the elongate member, a second end member adjustably attached to an end of the elongate member opposite of the first end member, a first engaging member removably positionable about the outer portion of the elongate member, and a second engaging member removably positionable about the outer portion of the elongate member. The elongate member preferably has a length greater than the width of the ladder for allowing the end members to be attached to with an object. The end members are formed for receiving various sizes of handles of an object. The engaging members are attached to opposing end portion of the elongate member when positioned within a rung for preventing the elongate member from accidentally becoming removed from the rung. In an alternative embodiment, a pair of handles are threadably connectable to a pair of corresponding threaded shafts extending from opposing ends of the elongate member.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to ladders and more specifically it relates to a ladder support rod system for supporting various types of objects in an elevated manner adjacent a ladder.

2. Description of the Prior Art

Ladders have been in use for years. A ladder is typically comprised of a pair of elongate support members with a plurality of rungs extending between the support members. The plurality of rungs within a metal or composite ladder are often times hollow with two opposing ends thereby defining an inner lumen.

The main problem with conventional ladders is that they do not provide a convenient and effective structure for supporting objects such as paint cans and containers. The user utilizing a ladder to paint a building structure often times has to utilize one hand to retain the paint can or similar container while attempting to paint with the other hand while simultaneously maintain their balance. Another problem with conventional ladders is that users sometimes place paint cans upon the rungs in an attempt to balance the paint can upon thereof which sometimes results in the paint can fall from thereof.

The only known commercialized products that attempt to solve the above problems with conventional ladders are comprised of a “hook” structure that are attached to the outer portion of the rungs of a ladder. The hook devices are basically comprised of a hook portion for engaging the outer surface of a rung with a receiving structure for receiving the object. However, conventional hook devices are not stable and must be removed prior to lowering the ladder when finished utilizing the ladder.

While these devices may be suitable for the particular purpose to which they address, they are not as suitable for supporting various types of objects in an elevated manner adjacent a ladder. Conventional ladders do not provide a convenient structure for supporting heavy objects such as paint cans and the like.

In these respects, the ladder support rod system according to the present invention substantially departs from the conventional concepts and designs of the prior art, and in so doing provides an apparatus primarily developed for the purpose of supporting various types of objects such as paint cans and containers in an elevated manner adjacent a ladder.

### SUMMARY OF THE INVENTION

In view of the foregoing disadvantages inherent in the known types of ladders now present in the prior art, the present invention provides a new ladder support rod system construction wherein the same can be utilized for supporting various types of objects in an elevated manner adjacent a ladder. The general purpose of the present invention, which will be described subsequently in greater detail, is to provide a new ladder support rod system that is not anticipated, rendered obvious, suggested, or even implied by any of the prior art ladder devices and accessories therefore, either alone or in any combination thereof.

To attain this, the present invention generally comprises an elongate member capable of slidably fitting within a lumen of a rung, a first end member adjustably attached to an end of the elongate member, a second end member adjustably attached to an end of the elongate member opposite of the first end member, a first engaging member removably positionable about the outer portion of the elongate member, and a second engaging member removably positionable about the outer portion of the elongate member. The elongate member preferably has a length greater than the width of the ladder for allowing the end members to be attached to with an object. The end members are formed for receiving various sizes of handles of an object. The engaging members are attached to opposing end portion of the elongate member when positioned within a rung for preventing the elongate member from accidentally becoming removed from the rung. In an alternative embodiment, a pair of handles are threadably connectable to a pair of corresponding threaded shafts extending from opposing ends of the elongate member.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a ladder support rod system that will overcome the shortcomings of the prior art devices.

A second object is to provide a ladder support rod system for supporting various types of objects in an elevated manner adjacent a ladder.

Another object is to provide a ladder support rod system that increases the overall safety for an individual utilizing a ladder.

An additional object is to provide a ladder support rod system that is capable of receiving and supporting various types of objects such as but not limited to paint cans and containers.

A further object is to provide a ladder support rod system that is attachable within various types and sizes of ladders.

Another object is to provide a ladder support rod system that may be installed at various levels along the ladder.

A further object is to provide a ladder support rod system that does not interfere with the ladder extension mechanism and which therefore may remain positioned within the ladder during and after usage of the ladder.

Another object is to provide a ladder support rod system that provides increased accessibility to tools required for a specific task while a user is upon a ladder without require the user to leave the ladder.

A further object is to provide a ladder support rod system that may support one or more objects simultaneously upon a ladder.

Another object is to provide a ladder support rod system that is usable by painters, carpenters, masons, homeowners, and various other individuals that utilize ladders.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an exploded upper perspective view of the present invention illustrating the resilient engaging members removed.

FIG. 3 is an exploded upper perspective view of the present invention illustrating the end members removed from the support tube.

FIG. 4 is a front cutaway view of the present invention.

FIG. 5 is an exploded upper perspective view of the present invention being inserted into a rung of a ladder.

FIG. 6 is an upper perspective view of the present invention inserted within the rung of a ladder.

FIG. 7 is a front view of the present invention within a ladder supporting a paint container.

FIG. 8 is an end view of the present invention positioned within the rung of a ladder.

FIG. 9 is an upper perspective view of the present invention supporting a paint container on one end thereof.

FIG. 10 is an exploded upper perspective view of an alternative embodiment of the present invention.

FIG. 11 is a cross sectional view taken along line 11-11 of FIG. 10 of the alternative embodiment.

FIG. 12 is a front view of the alternative embodiment within a ladder and supporting a paint container.

FIG. 13 is an upper perspective view of the alternative embodiment within a ladder and supporting a paint container.

FIG. 14 is a magnified upper perspective view of the first handle used within the alternative embodiment.

### DESCRIPTION OF THE PREFERRED EMBODIMENT

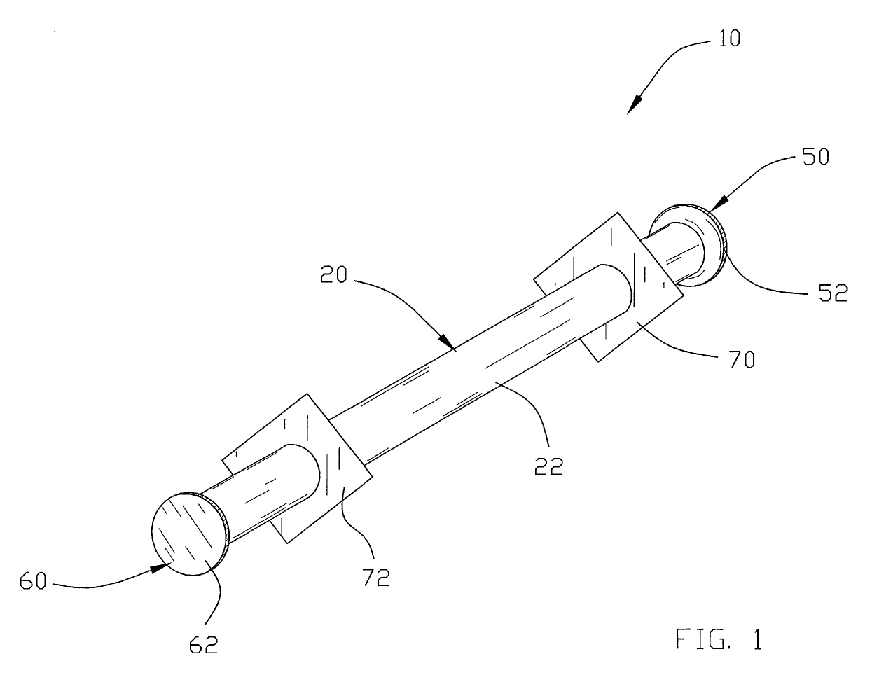

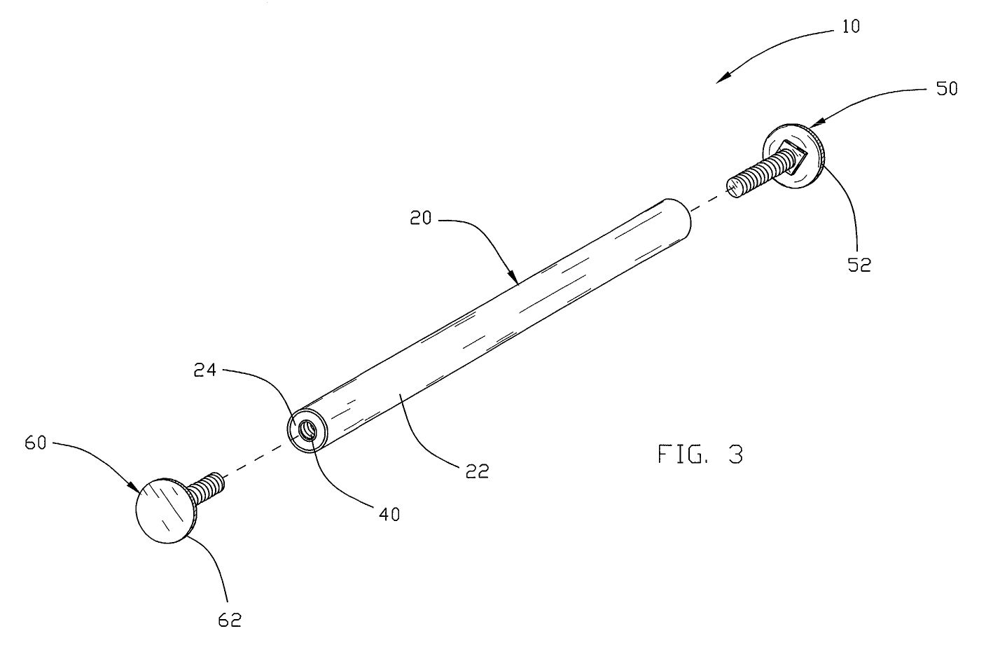

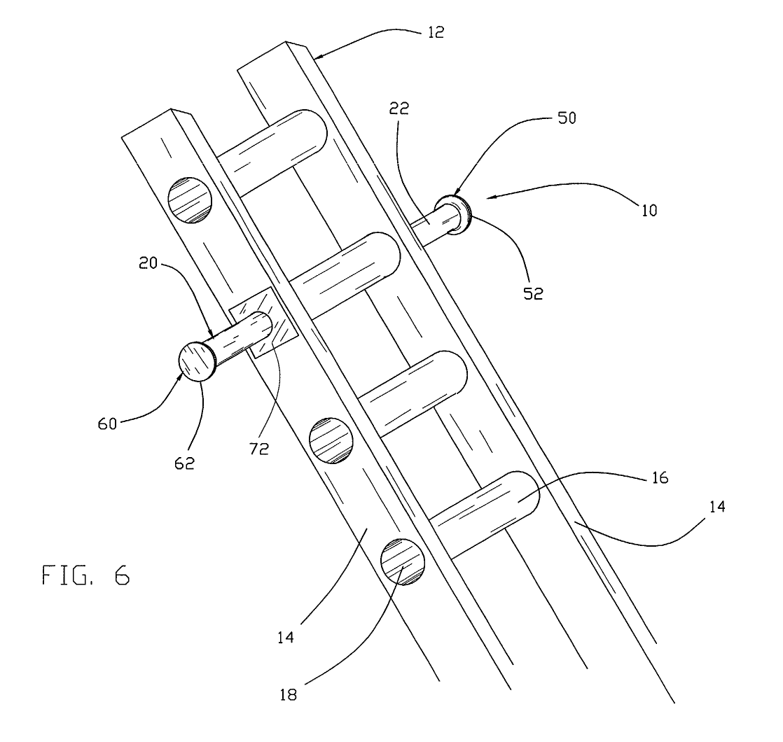

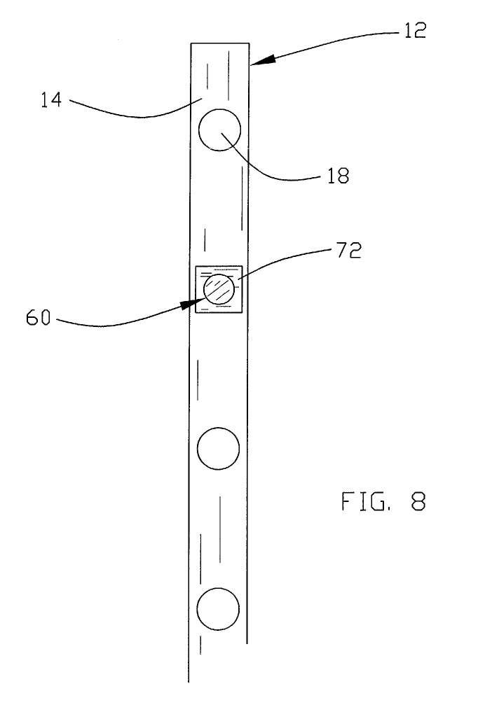

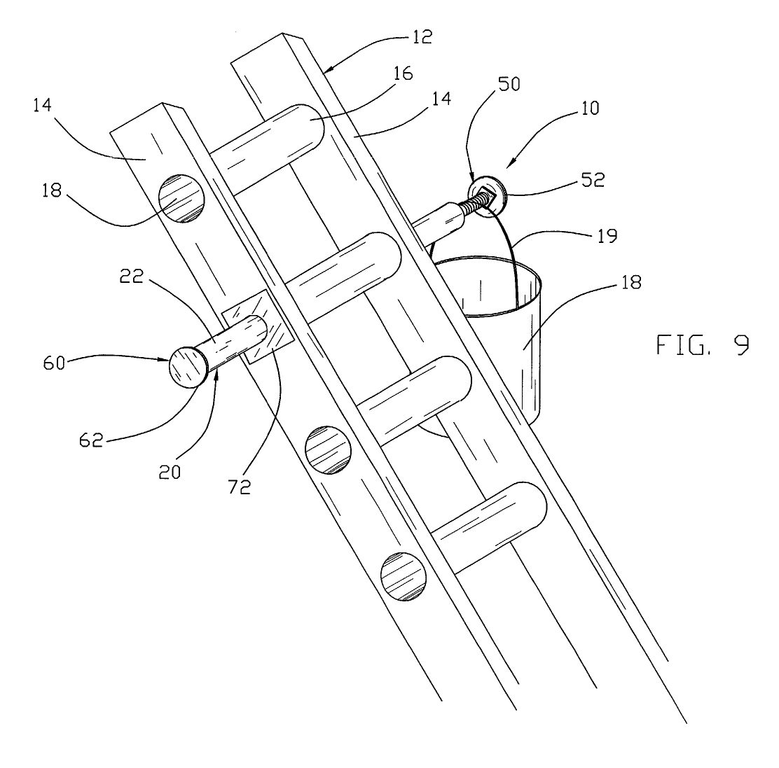

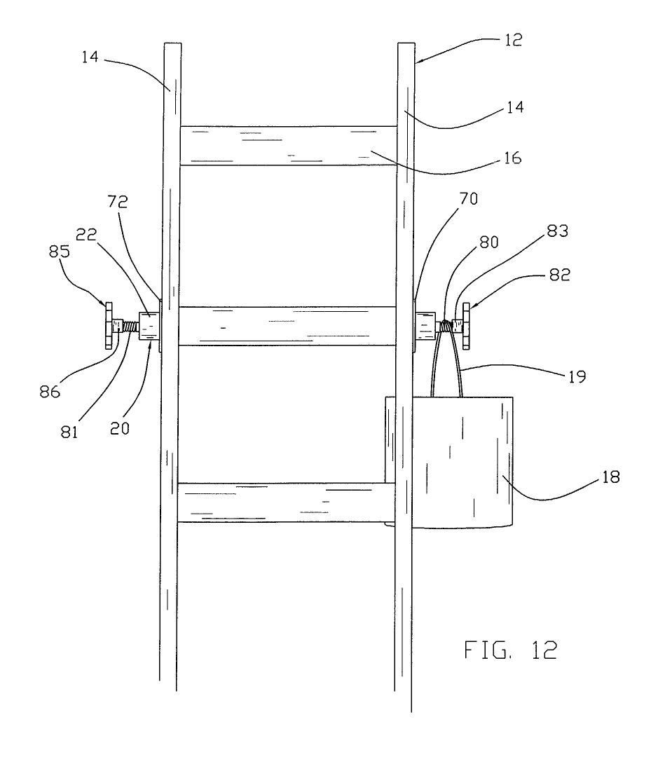

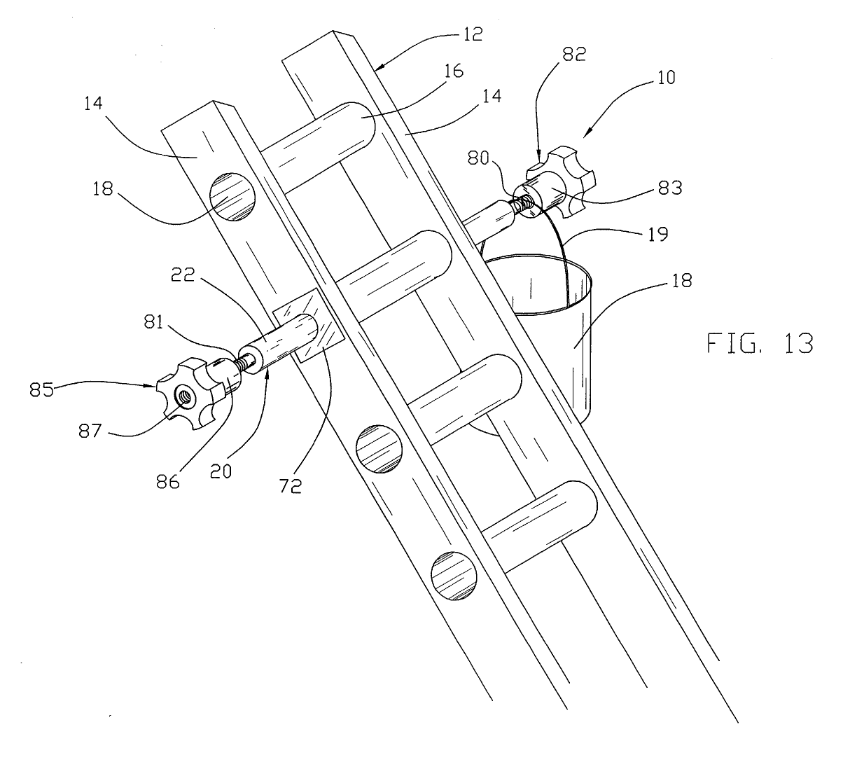

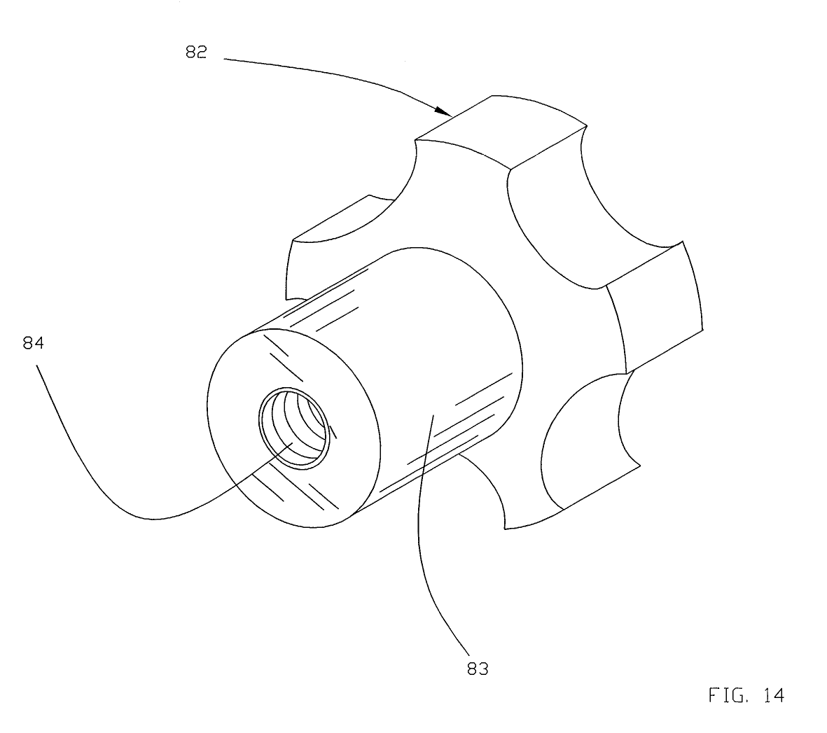

Turning now descriptively to the drawings, in which similar reference characters denote similar elements throughout the several views, FIGS. 1 through 14 illustrate a ladder support rod system 10, which comprises an elongate member 20 capable of slidably fitting within a lumen 17 of a rung, a first end member 50 adjustably attached to an end of the elongate member 20, a second end member 60 adjustably attached to an end of the elongate member 20 opposite of the first end member 50, a first engaging member 70 removably positionable about the outer portion 22 of the elongate member 20, and a second engaging member 72 removably positionable about the outer portion 22 of the elongate member 20. The elongate member 20 preferably has a length greater than the width of the ladder 12 for allowing the end members 50, 60 to be attached to with an object. The end members 50, 60 are formed for receiving various sizes of handles 19 of an object 18. The engaging members 70, 72 are attached to opposing end portion of the elongate member 20 when positioned within a rung 16 for preventing the elongate member 20 from accidentally becoming removed from the rung 16.

As shown in FIGS. 1 through 5 of the drawings, the elongate member 20 is comprised of an elongate structure having opposing ends. The elongate member 20 may be comprised of a solid or hollow structure as can be appreciated. The elongate member 20 may also be comprised of various types of materials, however the elongate member 20 must be comprised of a relatively strong material capable of supporting the weight of one or more objects 18.

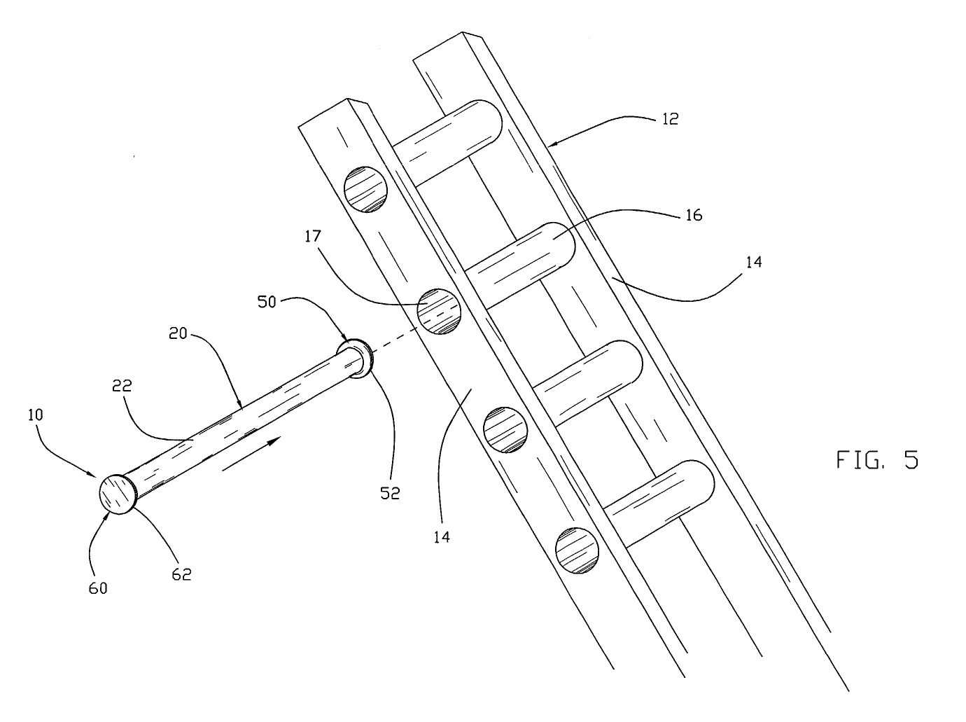

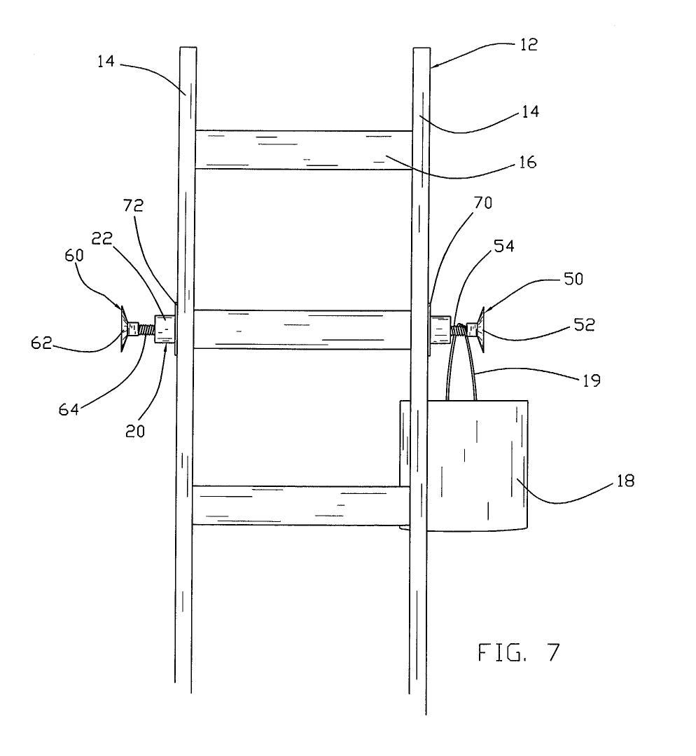

The elongate member 20 may have various cross sectional shapes such as but not limited to circular, square, rectangular and oval. The elongate member 20 has a size sufficient for insertion into the lumen 17 of any of the rungs 16 of the ladder 12 as shown in FIG. 5 of the drawings. The elongate member 20 further preferably has a length that is greater than the outer width of the support members 14 of the ladder 12 as shown in FIG. 7 of the drawings.

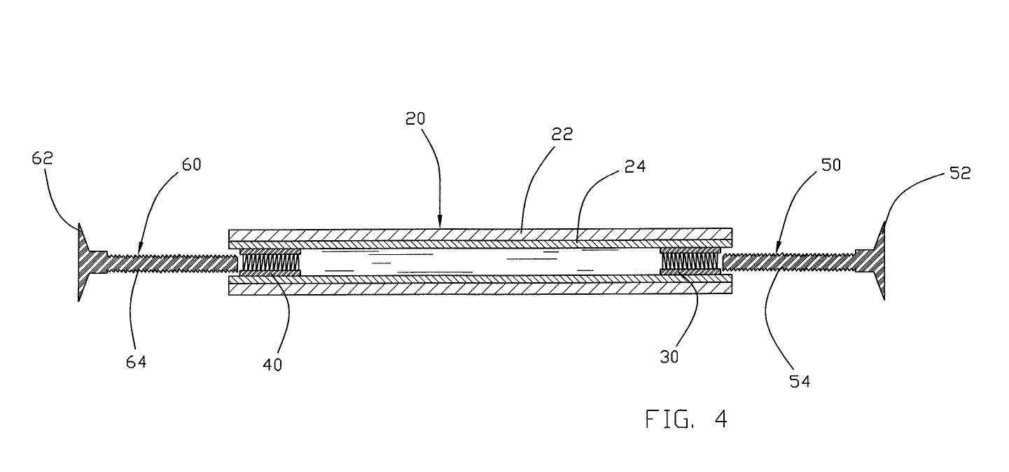

As shown in FIG. 4 of the drawings, the elongate member 20 may be comprised of an inner portion 24 and an outer portion 22 wherein the inner portion 24 is comprised of a rigid material such as but not limited to metal and the outer portion 22 is comprised of a resilient material such as but not limited to plastic. The elongate member 20 may be comprised of a various number of portions other than that illustrated within FIG. 4 of the drawings.

As shown in FIG. 4 of the drawings, a first interiorly threaded member 30 and a second interiorly threaded member 40 are positioned within the opposing ends of the elongate member 20. The interiorly threaded members 30, 40 are formed for threadably and adjustably receiving the end members 50, 60. It can be appreciated that the elongate member 20 may be bored and tapped at the distal ends thereof for creating interior threading for receiving the end members 50, 60.

As shown in FIGS. 1 through 7 of the drawings, the first end member 50 is comprised of a first threaded portion 54 having an elongate structure and a first flange 52 at a distal end thereof. The first end member 50 is formed for being able to receive various sizes of handles 19 from a container 18. The first flange 52 has a size sufficient for retaining the handle 19 of the container 18 positioned upon the first end member 50 and may have various shapes. The first flange 52 preferably has a size small enough to fit within the lumen 17 of the rungs 16, however the first flange 52 may have a size too large to fit within the lumen 17 thereby requiring removal of the first flange 52 prior to positioning the elongate member 20 within the lumen 17 of the rungs 16.

As shown in FIGS. 1 through 7 of the drawings, the second end member 60 is comprised of a second threaded portion 64 having an elongate structure and a second flange 62 at a distal end thereof. The second end member 60 is formed for being able to receive various sizes of handles 19 from a container 18. The second flange 62 has a size sufficient for retaining the handle 19 of the container 18 positioned upon the second end member 60 and may have various shapes. The second flange 62 preferably has a size small enough to fit within the lumen 17 of the rungs 16, however the second flange 62 may have a size too large to fit within the lumen 17 thereby requiring removal of the second flange 62 prior to positioning the elongate member 20 within the lumen 17 of the rungs 16.

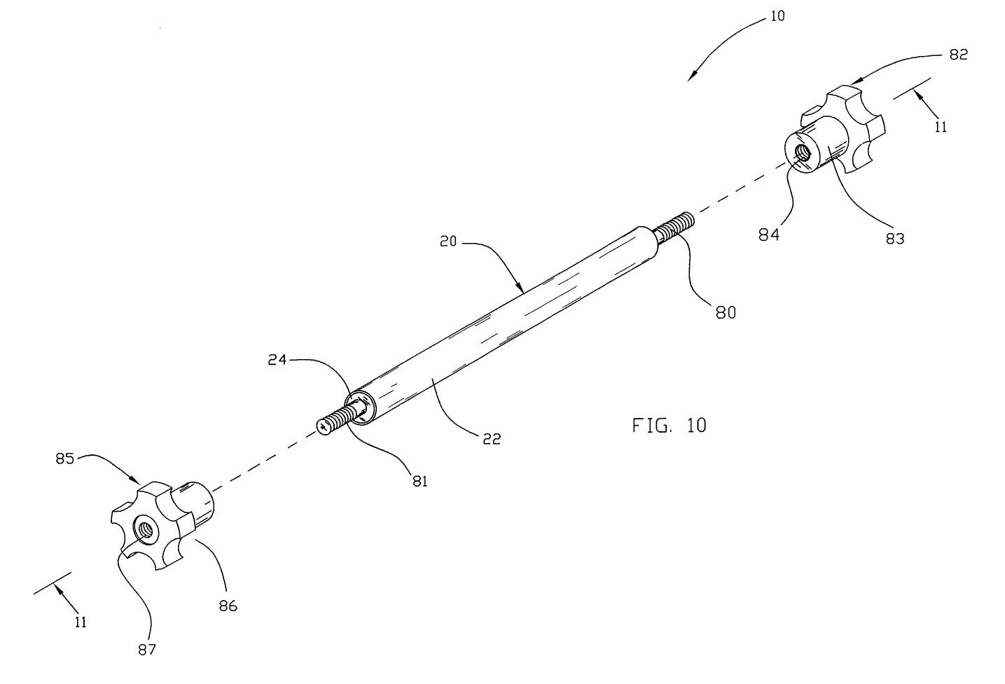

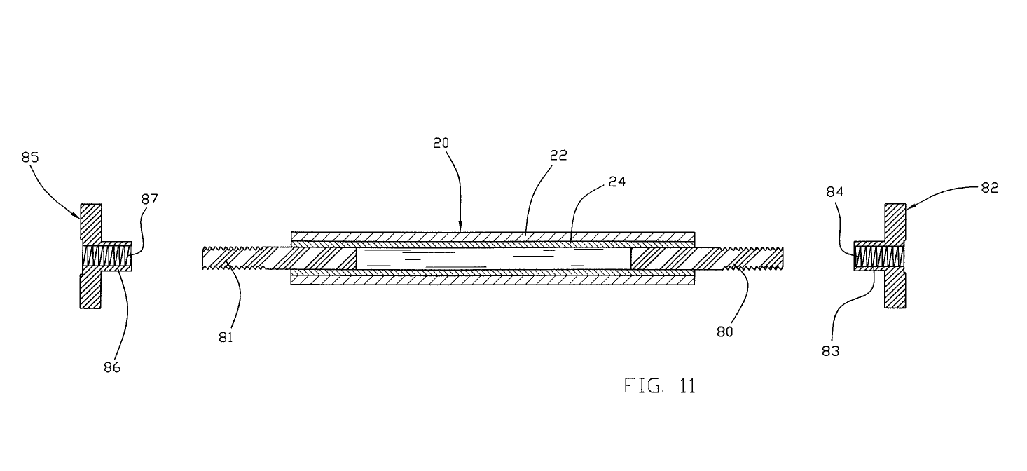

In an alternative embodiment shown in FIGS. 10 through 14 of the drawings, a first threaded shaft 80 is secured within the inner portion 24 of the elongate member 20. It can be appreciated that the first threaded shaft 80 may be secured to the distal end of the elongate member 20 instead of within the elongate member 20. A distal portion of the first threaded shaft 80 is exteriorly threaded for threadably receiving a corresponding first handle 82 as best shown in FIG. 10 of the drawings. As best shown in FIG. 11 of the drawings, an inner portion of the first threaded shaft 80 adjacent the elongate member is preferably not threaded to provide a “stop” that prevents the first handle 82 from proceeding further along the first threaded shaft 80 which results in a space between the end of the first handle 82 and the end of the elongate member that receives the handle 19 of a container 18. It can be appreciated that the first threaded shaft 80 may have various diameters and lengths as desired.

As further shown in the alternative embodiment as illustrated in FIGS. 10 through 14 of the drawings, the first handle 82 has a flanged portion and a first portion 83. The first portion 83 of the handle is preferably smaller in diameter than the flanged portion to provide a location for receiving the handle 19 of the container 18. The first portion 83 may have various widths in order to accommodate various items to be supported. The flanged portion preferably includes a plurality of recessed portions having a concave structure that extend transversely within the perimeter of the flanged portion of the first handle 82 for enhancing gripping by a user. A first interior threading 84 extends concentrically within the first handle 82 for threadably mating with the first threaded shaft 80. The first interior threading 84 is comprised of an opening that extends through the first handle 82. As shown in FIG. 11, the first interior threading 84 preferably extends completely through the first handle 82 to accommodate the length of the corresponding first threaded shaft 80.

As further shown in the alternative embodiment in FIGS. 10 through 14 of the drawings, a second threaded shaft 81 is secured within the inner portion 24 of the elongate member 20 opposite of the first threaded shaft 80. It can be appreciated that the second threaded shaft 81 may be secured to the distal end of the elongate member 20 instead of within the elongate member 20. A distal portion of the second threaded shaft 81 is exteriorly threaded for threadably receiving a corresponding second handle 85 as best shown in FIG. 10 of the drawings. As best shown in FIG. 11 of the drawings, an inner portion of the second threaded shaft 81 adjacent the elongate member is preferably not threaded to provide a “stop” that prevents the second handle 85 from proceeding further along the second threaded shaft 81 which results in a space between the end of the second handle 85 and the end of the elongate member that receives the handle 19 of a container 18. It can be appreciated that the second threaded shaft 81 may have various diameters and lengths as desired.

As further shown in the alternative embodiment as illustrated in FIGS. 10 through 14 of the drawings, the second handle 85 has a flanged portion and a second portion 86. The second portion 86 of the handle is preferably smaller in diameter than the flanged portion to provide a location for receiving the handle 19 of the container 18. The second portion 86 may have various widths in order to accommodate various items to be supported. The flanged portion preferably includes a plurality of recessed portions having a concave structure that extend transversely within the perimeter of the flanged portion of the second handle 85 for enhancing gripping by a user. A second interior threading 87 extends concentrically within the second handle 85 for threadably mating with the second threaded shaft 81. The second interior threading 87 is comprised of an opening that extends through the second handle 85. As shown in FIG. 11, the second interior threading 87 preferably extends completely through the second handle 85 to accommodate the length of the corresponding second threaded shaft 81.

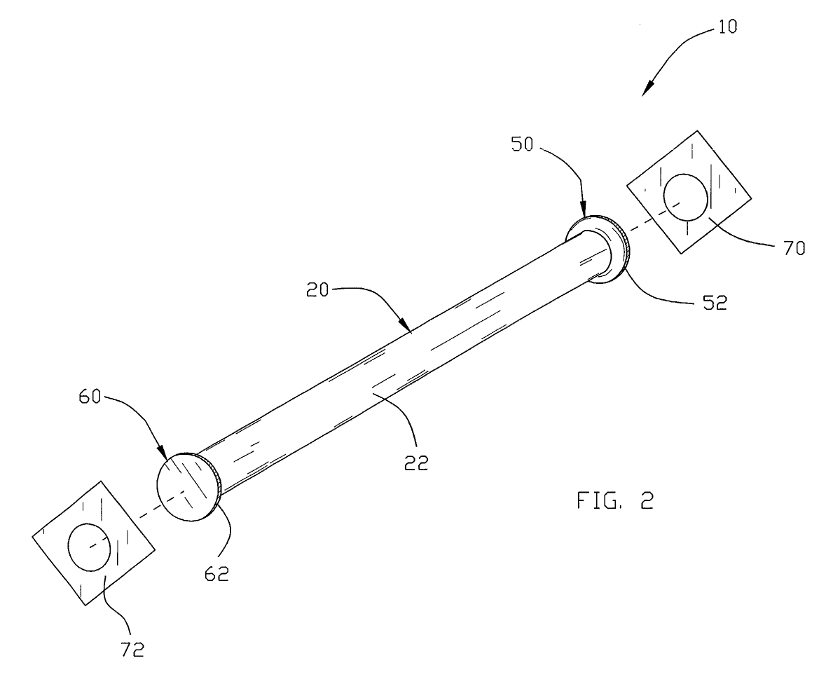

As shown in FIGS. 1 and 2 of the drawings, a first engaging member 70 and a second engaging member 72 are provided that have a center opening within. The engaging members 70, 72 are preferably comprised of a resilient material such as but not limited to rubber. The center opening within the engaging members 70, 72 is formed for snugly fitting about the outer surface of the elongate member 20. The engaging members 70, 72 are formed for retaining the elongate member 20 within the desired position within a rung 16 of the ladder 12. The engaging members 70, 72 are preferably larger in size than the lumen 17 of the rungs 16 and may have various shapes thereto. The engaging members 70, 72 may also be utilized in conjunction with the alternative embodiment of the present invention.

In use, the user inserts the elongate member 20 through the lumen 17 of the desired rung 16 at the desired elevation upon the ladder 12. After properly positioning the elongate member 20 within the rung 16, the user then secures the engaging members 70, 72 about the elongate member 20 on opposing ends thereof to retain the elongate member 20 positioned within thereof as shown in FIG. 7 of the drawings. The user then adjusts the end members 50, 60 to the desired extension for receiving the appropriate size of handle 19 of the container 18 as shown in FIG. 7 of the drawings. If the handle 19 is relatively large, the user will extend the end member 50, 60 outwardly from the elongate member 20. If the handle 19 is relatively small, the user will inwardly thread the appropriate end member 50, 60 to provide a tighter fit for the handle 19. The user then positions the handle 19 of the container 18 about the appropriate end member 50, 60 as shown in FIG. 7 of the drawings. It can be appreciated that another container 18 may be attached to an opposing end member 50, 60 or that multiple containers 18 may be attached to a single end member 50, 60 if desired. If the user desires to reposition the elongate member 20, the above process is simply reversed and then repeated with respect to the new rung. The alternative embodiment of the present invention is utilized in a manner similar to the main embodiment as discussed above.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A ladder support rod system, comprising:
an elongate member having a first end, a second end, a length, and a width;
wherein said width of said elongate member is smaller than a lumen of a rung of a ladder;
wherein said length of said elongate member is greater than a width of said ladder;
a first end member attached within said first end of said elongate member for receiving a first object; and
a second end member attached within said second end of said elongate member for receiving a second object.

2. The ladder support rod system of claim 1, wherein said first end member and said second end member are adjustably positioned within said first end and said second end respectively.

3. The ladder support rod system of claim 2, wherein said first end member and said second end member each have a flanged end and a threaded portion for threadably engaging said first end and said second end respectively.

4. The ladder support rod system of claim 3, wherein said elongate member includes a first interiorly threaded member within said first end for receiving said threaded portion of said first end member, and a second interiorly threaded member within said second end for receiving said threaded portion of said second end member.

5. The ladder support rod system of claim 1, wherein said elongate member is comprised of an inner portion and an outer portion surrounding said inner portion.

6. The ladder support rod system of claim 5, wherein said inner portion is comprised of a rigid metal and wherein said outer portion is comprised of a resilient material.

7. The ladder support rod system of claim 6, wherein said elongate member has a circular cross sectional shape.

8. The ladder support rod system of claim 1, wherein said length of said elongate member is greater than a width of said ladder by at least two inches.

9. The ladder support rod system of claim 1, wherein said first end member and said second end member have a size smaller than said lumen of said rung.

10. The ladder support rod system of claim 1, including a first engaging member and a second engaging member for positioning about opposing distal portions of said elongate member for securing said elongate member within said rung, wherein said engaging members each have a central opening and are comprised of a resilient material for snugly engaging an outer surface of said elongate member.

11. A ladder support rod system, comprising:
an elongate member having a first end, a second end, a length, and a width;
wherein said width of said elongate member is smaller than a lumen of a rung of a ladder;
wherein said length of said elongate member is greater than a width of said ladder;
a first shaft extending from said first end of said elongate member;
a first handle attached to said first shaft for receiving a first object;
a second shaft extending from said second end of said elongate member; and
a second handle attached to said second shaft for receiving a second object.

12. The ladder support rod system of claim 11, wherein said first shaft and said second shaft each have distal exterior threaded portions, and wherein said first handle and said second handle each have interior threaded openings for threadably attaching to said first shaft and said second shaft respectively.

13. The ladder support rod system of claim 12, wherein said first handle and said second handle each have a flanged portion and a body portion.

14. The ladder support rod system of claim 13, wherein said flanged portion is includes a plurality of recessed portions within for gripping.

15. The ladder support rod system of claim 11, wherein said elongate member is comprised of an inner portion and an outer portion surrounding said inner portion.

16. The ladder support rod system of claim 15, wherein said inner portion is comprised of a rigid metal and wherein said outer portion is comprised of a resilient material.

17. The ladder support rod system of claim 16, wherein said elongate member has a circular cross sectional shape.

18. The ladder support rod system of claim 11, wherein said length of said elongate member is greater than a width of said ladder by at least two inches.

19. The ladder support rod system of claim 11, wherein said first handle and said second handle each have a size smaller than said lumen of said rung.

20. The ladder support rod system of claim 11, including a first engaging member and a second engaging member for positioning about opposing distal portions of said elongate member for securing said elongate member within said rung, wherein said engaging members each have a central opening and are comprised of a resilient material for snugly engaging an outer surface of said elongate member.
